(19) United States
(12) Patent Application Publication
(10) Pub. No.: US 2023/0222640 A1
(43) Pub. Date: Jul. 13, 2023

(54) Method for Recognizing Image Artifacts, Control Device for Carrying Out a Method of this Kind, Recognition Device Having a Control Device of this Kind and Motor Vehicle Having a Recognition Device of this Kind

(71) Applicant: DAIMLER AG, Stuttgart (DE)

(72) Inventor: Fridtjof STEIN, Ostfildern (DE)

(21) Appl. No.: 17/928,237

(22) PCT Filed: Apr. 15, 2021
(86) PCT No.: PCT/EP2021/059799

§ 371 Date: Nov. 28, 2022

(30) Foreign Application Priority Data
May 28, 2020 (DE) 10 2020 003 199.4

(51) Int. Cl. G06T 7/00; G06T 7/20; H04N 23/56

(52) U.S. Cl. CPC G06T 7/0002; G06T 7/20; H04N 23/56; G06T 2207/20084; G06T 2207/30252; G06T 2207/10016; G01S 17/86

(57) ABSTRACT

A method for recognizing image artifacts in a chronological sequence of recordings recorded by means of a lighting device and an optical sensor is disclosed. A difference movement field is obtained by removing from a movement field all movement field vectors to be expected due to inherent movement of a lighting device and an optical sensor. The movement field vectors in the difference movement field are combined into one or more objects according to at least one grouping criterion. The objects in the image are classified as plausible or as implausible pursuant to a movement plausibility test. An object classified as implausible is recognized as an image artifact.

### BACKGROUND AND SUMMARY OF THE INVENTION

The invention relates to a method for recognizing image artifacts, a control device for carrying out a method of this kind, a recognition device having a control device and a motor vehicle having a recognition device.

International patent application having the publication number WO 2017/009848 A1 describes a method in which a lighting device and an optical sensor are controlled in a manner chronologically coordinated with each other in order to record a particular visible distance region in an observation region of the optical sensor. The occurrence of image artifacts and/or the recognition of artifacts in the recordings of the optical sensor are not discussed there, however.

The object of the invention is thus to create a method for recognizing image artifacts, a control device for carrying out a method of this kind, a recognition device having a control device of this kind and a motor vehicle having a recognition device of this kind, wherein the disadvantages given are at least partially remedied, preferably avoided.

The object is in particular solved by creating a method for recognizing image artifacts in a chronological sequence of recordings recorded by means of a lighting device and an optical sensor. The lighting device and the optical sensor are shifted by means of an inherent movement. The lighting device and the optical sensor are here controlled in a manner chronologically coordinated with each other, and at least two recordings following one after the other are recorded with the optical sensor by means of the chronologically coordinated control. A movement field having movement field vectors is calculated from the at least two recordings following one after the other. All movement field vectors that are to be expected due to the inherent movement of the lighting device and the optical sensor are then removed from the movement field, whereby a difference movement field is obtained. The movement field vectors are combined into objects in the image in the difference movement field according to at least one grouping criterion. The objects in the image undergo a movement plausibility test. The objects in the image are classified as plausible or as implausible by means of the movement plausibility test. An object classified as implausible is lastly recognized as an image artifact.

It is advantageously possible by means of the method proposed herein to recognize image artifacts, in particular reflections of retroreflective and/or photoluminescent objects on the lens of the optical sensor. The recognition prevents miscalculations and misinterpretations of these image artifacts.

The method can particularly advantageously be used in automated vehicles, in particular automated trucks. The method enables a recognition of image information that is not constituted by depictions of real objects, but instead by reflections, for example. In particular, a response of the vehicle that is not necessary can thus be prevented.

The method for generating recordings by means of a control of lighting device and optical sensor chronologically coordinated with each other is in particular a method known as a gated image method; the optical sensor is in particular a camera that is sensitively connected only in a particular, limited time window, which is described as gated control; the camera is thus a gated camera. The lighting device too is correspondingly chronologically only controlled within a particular, selected time interval in order to illuminate scenery on the object side.

A pre-defined number of light impulses is in particular emitted via the lighting device, preferably having a duration between 5 ns and 20 ns. The beginning and end of the exposure of the optical sensor is dependent on the number and duration of emitted light impulses. As a result, a determined visible distance region can be recorded via the optical sensor by the chronological control of the lighting device on the one hand and on the other the optical sensor with a correspondingly defined local position, i.e., in particular a determined distance of the beginning of the distance region of the optical sensor and a determined distance region breadth.

The visible distance region is here the region—on the object side—in three-dimensional space that is depicted via the number and duration of the light impulses of the lighting device in conjunction with the start and end of the exposure of the optical sensor by means of the optical sensor in a two-dimensional recording in an image plane of the optical sensor.

By contrast, the observation region is in particular the region—on the object side—in three-dimensional space that could be depicted entirely—in particular maximally—in the event of sufficient lighting and exposure of the optical sensor by means of the optical sensor in a two-dimensional recording. The observation region in particular corresponds to the entire exposable image region of the optical sensor that could theoretically be lit. The visible distance region is thus a partial quantity of the observation region in actual space.

Wherever the term “on the object side” is used here and in the following, a region in actual space, i.e., to sides of the object to be observed, is meant. Wherever the term “in the image” is used here and in the following, a region in the image plane of the optical sensor is meant. The observation region and the visible distance region are here given on the object side. Associated regions in the image plane in the image correspond to said observation region and the visible distance region via the laws of imagery and the chronological control of the lighting device and the optical sensor.

Light impulse photons hit the optical sensor, depending on the start and end of the exposure of the optical sensor after the beginning of the lighting by the lighting device. The further apart the visible distance region is from the lighting device and the optical sensor, the longer the chronological duration until a photon that is reflected in this distance region hits the optical sensor. The chronological distance between an end of the lighting and a beginning of the exposure is thus longer, the further the visible distance region is away from the lighting device and the optical sensor.

According to an embodiment of the method, it is thus in particular possible to define the position and spatial breadth of the visible distance region via a corresponding suitable choice of the chronological control of the lighting device on the one hand and the optical sensor on the other.

In an alternative embodiment of the method, the visible distance region can be given, wherein the chronological coordination of the lighting device on the one hand and the optical sensor on the other is thus determined and correspondingly given.

The lighting device is a laser in a preferred embodiment. The optical sensor is a camera in a preferred embodiment.

The movement of individual pixels of the recordings as vectors in the image represents a movement field of a series of at least two recordings. The movement field of a series of recordings is an easily-implemented method for visualizing movements in a series of recordings.

In a preferred embodiment, the inherent movement of the lighting device and the optical sensor is depicted by means of expected movement field vectors. A first movement field vector of the chronological sequence of recordings, and a second, expected movement field vector of the inherent movement of the lighting device and the optical sensor thus exists for each point on the optical sensor. The first movement field vector and the respectively associated second movement field vector are checked for similarity at each point of the optical sensor. Two vectors are preferably similar if the angle that is formed by the two vectors lies below a determined first threshold. The difference movement field then contains all first movement field vectors that are not similar to the particular associated second movement field vector.

The individual movement field vectors from the difference movement field are combined into objects in the image by means of the at least one grouping criterion.

The movement plausibility test preferably analyses the physical properties, such as size, change in size, speed, change in speed and direction of movement of the objects in the image. If an object has a contradictory combination of at least two of these qualities, then the object is classified as implausible. For example, the combination of moving upwards in the image and getting bigger is contradictory, and an object in the image that behaves thus is classified as implausible.

According to a development of the invention, it is provided that the at least one grouping criterium is selected from a group consisting of a spatial proximity and a vector similarity. In a preferred embodiment, the grouping of the movement field vectors occurs by means of the spatial proximity and the vector similarity as grouping criteria. The spatial proximity ensures that only movement field vectors having at most a certain pre-defined spacing from one another are combined into objects in the image. The vector similarity ensures that only movement field vectors are combined that form at most a small angle, in particular smaller than a second threshold value, or the direction of which has only a small variation, in particular smaller than a third threshold value. The corresponding threshold values for the spacing of the movement field vectors and for the angle between the movement field vectors are pre-defined and can vary depending on the sequence of the recordings.

According to a development of the invention, it is provided that the movement plausibility test is carried out by means of a neural network.

According to a development of the invention, it is provided that the recognized image artifacts are verified by means of a LIDAR system. The distance and speed measurement of a LIDAR system is advantageously used to recognize objects in the observation region of the optical sensor. A simple verification is thus possible of whether an image artifact can be seen in the recordings.

According to a development of the invention, it is provided that the recognized image artifacts are verified by means of a radar system. The distance and speed measurement of a radar system is advantageously used to recognize objects in the observation region of the optical sensor. A simple verification is thus possible of whether an image artifact can be seen in the recordings.

According to a development of the invention, it is provided that the recognized image artifacts are verified by means of an additional optical sensor. The optical sensor and the second optical sensor advantageously differ in relation to the wavelength region of the light of the exposure. A simple verification is thus possible of whether an image artifact can be seen in the recordings.

The object is also solved by creating a control device that is equipped to carry out a method according to the invention or a method according to one of the previously described embodiments. The control device is preferably formed as a computing device, in particular preferably as a computer, or as a control unit, in particular as a control unit of a vehicle. In conjunction with the control device, the advantages in particular result that have already been explained in conjunction with the method.

The control device is preferably operatively connected to the lighting device on the one hand and to the optical sensor on the other, and is equipped to control them.

The object is also solved by creating a recognition device that has a lighting device, an optical sensor and a control device according to the invention or a control device according to one of the previously described exemplary embodiments. In conjunction with the recognition device, the advantages in particular result that have already been explained in conjunction with the method and the control device.

The object is finally also solved by creating a motor vehicle having a recognition device according to the invention or a recognition device according to one of the previously described exemplary embodiments. In conjunction with the motor vehicle, the advantages in particular result that have already been explained in conjunction with the method, the control device and the recognition device.

In an advantageous embodiment, the motor vehicle is formed as a truck. It is also possible, however, that the motor vehicle is a passenger car, a commercial vehicle or another motor vehicle.

### BRIEF DESCRIPTION OF THE DRAWINGS

FIG. 1 shows a schematic depiction of an exemplary embodiment of a motor vehicle with an exemplary embodiment of a recognition device, and

FIG. 2 shows a schematic depiction of a recording that has been recorded within the scope of an embodiment of the method by an optical sensor.

### DETAILED DESCRIPTION OF THE DRAWINGS

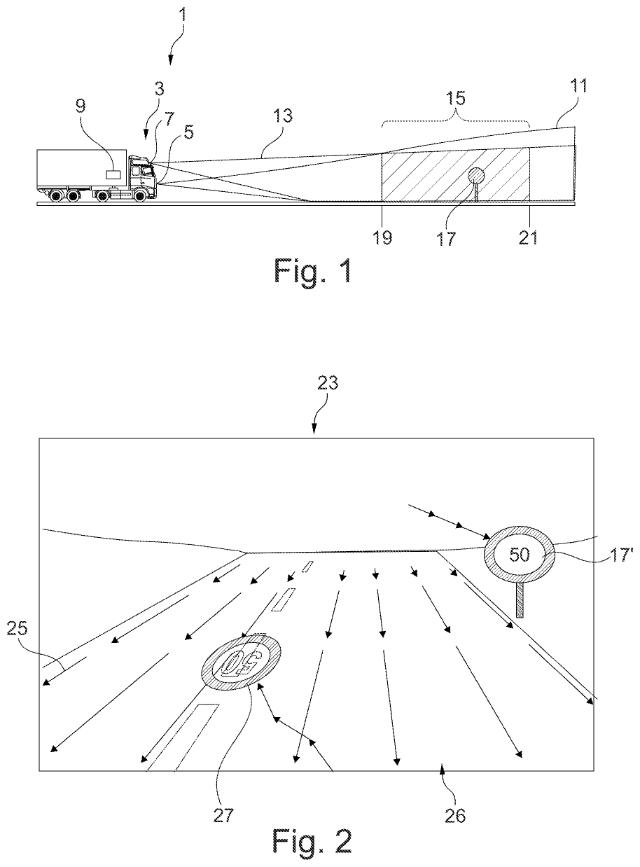

FIG. 1 shows a schematic depiction of an exemplary embodiment of a motor vehicle 1, with an exemplary embodiment of a recognition device 3. The recognition device 3 has a lighting device 5 and an optical sensor 7. The recognition device 3 additionally has a control device 9 (here only depicted schematically) that is operatively connected (in a manner not explicitly depicted) to the lighting device 5 and the optical sensor 7 in order to control them respectively. A lighting frustum 11 of the lighting device 5 and an observation region 13 of the optical sensor 7 is in particular depicted in FIG. 1. A visible distance region 15 that is a partial quantity of the observation region 13 of the optical sensor 7 is also depicted in a cross-hatched manner.

An object 17 is arranged in the visible distance region 15.

A beginning 19 and an end 21 of the visible distance region 15 is also illustrated in FIG. 1.

The control device 9 is in particular equipped to carry out an embodiment of a method for recognizing image artifacts described in more detail in the following.

The lighting device 5 and the optical sensor 7 are here controlled in a manner chronologically coordinated with each other, wherein a visible distance region 15 in the observation region 13 is given from the chronological coordination of the control of the lighting device 5 and the optical sensor 7. A chronological sequence of recordings of the visible distance region 15 is recorded with the optical sensor 7 using the coordinated control.

FIG. 2 shows a schematic depiction of a recording 23 of a chronological sequence of recordings of this kind in an image plane of the optical sensor 7. Movement field vectors 25 of a road 26, a first object 17′ in the image and a second object 27 in the image are here schematically depicted as arrows in FIG. 2. Only one arrow is provided with a reference numeral in order to provide a clear presentation. The movement field vectors 25 of the road 26 correspond to an expected movement field that occurs due to an inherent movement of the lighting device 5 and the optical sensor 7. The first object 17′ in the image is furthermore the image of the object 17 on the object side. The second object 27 in the image is depicted as a reflection of the object 17 on the object side. The movement field vectors 25 of the first object 17′ in the image are similar—in direction and length—to the movement field vectors 25 of the road 26. The movement field vectors 25 of the first object 17′ in the image thus correspond to the expected movement field. The movement field vectors 25 of the second object 27 in the image differ clearly in direction and length from the movement field vectors 25 of the road 26, and thus also from the expected movement field. A difference movement field thus consists of the movement field vectors 25 of the second object 27 in the image. The movement field vectors 25 in the difference movement field are preferably combined into the second object 27 in the image and its movement by means of spatial proximity and vector similarity in the image. The movement field vectors 25 of the second object 27 in the image depict an upward movement and an increase in object size that is not depicted in FIG. 2. A movement plausibility test classifies this behavior—upward movement and increase in size—as implausible. The second object 27 in the image is thus recognized as an image artifact.

1-9. (canceled)

10. A method for recognizing image artifacts in a chronological sequence of recordings recorded by means of a lighting device and an optical sensor, comprising:
shifting the lighting device and the optical sensor by means of an inherent movement;
controlling the lighting device and the optical sensor in a manner chronologically coordinated with each other;
recording at least two recordings following one after the other with the optical sensor by means of the chronologically coordinated control;
calculating a movement field having movement vectors of the at least two recordings following one after the other is calculated;
obtaining a difference movement field by removing from the movement field all movement field vectors to be expected due to the inherent movement;
combining the movement field vectors into one or more objects in the image in the difference movement field according to at least one grouping criterion; and
classifying the objects in the image as plausible or as implausible pursuant to a movement plausibility test; and
recognizing as an image artifact an object of the one or more objects in the image classified as implausible.

11. The method of claim 10, further comprising:
selecting the at least one grouping criterion from a group consisting of: a spatial proximity and a vector similarity criterion.

12. The method of claim 10, wherein the movement plausibility test is carried out by means of a neural network.

13. The method of claim 10, wherein the recognized image artifacts are verified by means of a LIDAR system.

14. The method of claim 10, wherein the recognized image artifacts are verified by means of a radar system.

15. The method of claim 10, wherein the recognized image artifacts are verified by means of an additional optical sensor.

16. A system, comprising:
a control device configured to execute the method of claim 10.

17. A recognition device, comprising:
the lighting device;
the optical sensor, and
a control device configured to execute the method of claim 10.

18. A motor vehicle, comprising:
the recognition device of claim 17.
